(19) United States
(12) Patent Application Publication
(10) Pub. No.: US 2004/0131783 A1
(43) Pub. Date: Jul. 8, 2004

(54) Method and apparatus for extracting impurities on a substrate

(76) Inventor: Sung-Jae Lee, Yongin-city (KR)

Correspondence Address: LEE & STERBA, P.C., Suite 2000, 1101 Wilson Boulevard, Arlington, VA, 22209, US

(21) Appl. No.: 10/740,571

(22) Filed: Dec. 22, 2003

(30) Foreign Application Priority Data
Dec. 23, 2002 (KR) 2002-82413

(51) Int. Cl. B05D 3/00

(52) U.S. Cl. 427/352; 257/E21.224; 438/906

(57) ABSTRACT

An apparatus and method for extracting impurities from a layer on a substrate includes decomposing the layer on the substrate to expose impurities and extracting the impurities from the substrate. During the decomposing, reacting material may be supplied to the layer as an aerosol. By detecting and monitoring the volume of discharged material from the decomposing, an end point of decomposing may be determined. Surface tension may be provided to extraction solution during extracting to prevent the extraction solution from separating from a nozzle injecting the extraction solution and from being locally saturated with impurities. A receiving module for receiving various sizes of the wafer may be included.

### BACKGROUND OF THE INVENTION

1. Field of the Invention

The present invention relates to a method and an apparatus for extracting impurities on a substrate, and more particularly to a method and an apparatus for extracting impurities in a layer coated on the substrate for fabricating semiconductor devices to allow analysis of the impurities.

2. Description of the Related Art

Highly integrated semiconductor devices are manufactured through numerous unit processes starting with supplying the semiconductor substrate, e.g., a silicon substrate. Therefore, the purity level of the semiconductor substrate in each unit process has a great effect on the operational characteristic of the semiconductor device. As wafer size increases and/or as patterns on the wafer have higher resolutions, the impurities on the surface of the silicon wafer become more responsible for malfunctions of the semiconductor device. Therefore, wafer impurity is a problem that needs to be addressed in order to realize higher manufacturing productivity of the semiconductor device.

Impurities absorbed in the wafer (hereinafter, referred to as absorbed impurities) are usually divided into two categories, a particle type and a molecular ion type. Both types of absorbed impurities can result in the malfunction of the semiconductor devices. Hence, much research has been performed on how to analyze the characteristics of the absorbed impurities.

Wet chemical analysis is most widely used for analyzing the absorbed impurities, since a microanalysis on the impurities can be carried out. In wet chemical analysis, the absorbed impurities on the wafer are extracted into a specific solution, and the solution including the impurities is analyzed to determine the content and ingredient of the impurities. However, in wet chemical analysis, analysis accuracy is mainly influenced by the sampling error of a target solution, rather than by the device error of the analysis system. That is, the analysis accuracy in wet chemical analysis is more strongly influenced by sampling errors such as contamination of the impurities in extracting the impurities, recovery rate of the solution including the extracted solution, or extraction efficiency. Therefore, each factor for the sampling error needs to be controlled in extracting the impurities. In addition, due to the extraction, wet chemical analysis is only useful for analyzing metal particle type impurities.

A conventional extracting device for extracting impurities on the surface of the wafer includes a wafer-receiving module for receiving the wafer to load/unload the wafer, a decomposing module for decomposing the layer coated on the wafer surface and exposing the impurities in the layer, and an extracting module for extracting the exposed impurities using an extraction solution and recovering the mixed solution including the impurities.

According to a contamination test using the conventional extracting device, first, the wafer-receiving module receives an object wafer to be tested. Then, a robot arm removes the object wafer from the wafer-receiving module and transfers the object wafer to the decomposing module. The layer on the object wafer is decomposed by chemical reaction in a processing chamber of the decomposing module, and product gases are discharged from the chamber. As a result, only impurities remain on the wafer surface. The wafer on which only the impurities remain is transferred to the extracting module by the robot arm. Then, a nozzle injects an extraction solution to the wafer surface. The extraction solution is suspended from the nozzle to the wafer surface due to the surface tension. Therefore, when the nozzle moves over the entire surface of the wafer, the extraction solution droplet also moves over the entire wafer surface by the surface tension, so the extraction solution can absorb impurities on the wafer surface. The extraction solution including the impurities is recovered and analyzed to determine the content and composition of the impurities.

However, the conventional extracting device has the following problems:

First, the conventional extracting device cannot analyze the impurities on a large wafer. The wafer-receiving module of the conventional extracting device is designed only to receive the 150 mm wafer, so that a 200 mm wafer or 300 mm wafer cannot be received. For these larger wafers, the extracting process is carried out using an additional device capable of them. As a result, the additional device has to be exchanged for the conventional device. Therefore, the continuity of the extracting process is disrupted and process efficiency is decreased, so that the overall cost for manufacturing the semiconductor device is increased.

Second, the decomposing velocity of the layer on the wafer cannot be improved sufficiently enough to increase manufacturing efficiency. The decomposing velocity of the layer is proportional to the volume of reacting gas, most of which is HF gas, in the decomposing module. Liquid HF is heated to become gaseous HF, which is then provided into the processing chamber of the decomposing module. The more gaseous HF is provided into the chamber, the lower the vapor pressure of the HF gas is and the less the influx volume of the HF gas provided into the chamber is. That is, the influx flow of the HF gas is not steady over time, so that the decomposing velocity of the layer is limited from a structural point of view.

Thermodynamic theory sets forth that the volume of the saturated vapor is always constant at a particular temperature and pressure, referred to as saturation temperature and saturation pressure, respectively. Therefore, both the saturation temperature and the saturation pressure need to be controlled to increase the volume of the saturated vapor. However, the practical variance range of the saturation temperature and pressure is very limited under the atmospheric pressure. In addition, even if the saturation temperature and pressure is sufficiently varied so that the variance range is considerably large, the increase of the saturated vapor volume is so small that this increase is not worth the high cost of controlling the temperature and pressure. Since the reacting gas needs to be capable of changing from a liquid state to a gaseous state at a reasonable temperature and pressure, it is difficult to substitute another reacting gas for the HF gas. Therefore, when the wafer is coated with the layer that does not react with HF gas, the layer cannot be decomposed in the conventional decomposing module. As a result, the impurities on the wafer cannot be analyzed.

Third, the processing chamber in the decomposing module is hermetically sealed, blocking a view of the inside of the processing chamber. Therefore, the decomposing process for the layer cannot be observed. Instead, the decomposing of the layer on the wafer is terminated based on an operator's experience. If the layer is not completely decomposed over the entire wafer surface, the successive extraction process cannot be performed. Therefore, the end point of the decomposing process is set by adding a margin of safety to the end point determined by the operator. The margin of safety is conventionally set to about 30% of the expected end point. Since the margin of safety is added for every wafer decomposed in the conventional decomposing process, the processing time for the decomposing process may be wastefully overestimated.

The processing capacity and accuracy of the decomposing process is mainly determined by the decomposing time and the end point, so these are deciding factors in determining the working capacity of the extraction device. Therefore, controlling the provision of the HF gas and accurately determining the earliest end point of the decomposing process are key factors for increasing the working capacity and accuracy of the extracting device.

Fourth, there is a problem that the structure of the nozzle in the conventional extracting device reduces an extracting efficiency.

The nozzle for injecting the extraction solution on the wafer has a tube structure. As a result, the wafer-contacting surface with which the extraction solution makes contact on the wafer is much larger than the nozzle-contacting surface with which the extraction solution makes contact on the nozzle surface. Therefore, the first surface tensile force of the extraction solution applied on the wafer surface is much stronger than the second surface tensile force of the extraction solution applied on the surface of the nozzle. This results in a breakdown of the extraction solution hanging from the nozzle on the wafer surface. Consequently, not all of the extraction solution including the impurities can be recovered or taken back to an analyzer, thus decreasing the extracting efficiency. The extracting efficiency is even further decreased when stepped portions are formed on the wafer surface because the wafer-contacting surface is increased in proportion with the stepped portions. In addition, the extraction solution has a tendency to stick to the wafer surface rather than to be smoothly circulated within itself, since the first surface tensile force is stronger than the second surface tensile force. Therefore, the impurities are extracted only into the extraction solution adjacent to the wafer surface, and the extraction solution adjacent to the nozzle cannot be used for extracting the impurities. As a result, when the extraction solution adjacent to the wafer surface is saturated with the impurities, the impurities cannot be extracted into the extraction solution even though the extraction solution adjacent to the nozzle is not saturated with impurities. Therefore, the amount of impurities extracted in practice is less than the actual amount of impurities, thereby reducing an extraction efficiency of the extraction solution.

As described above, process efficiency is decreased as the wafer size is diversified. Additionally, the kind of layer to be decomposed and the decomposing rate of the layer are restricted by using HF gas as the reacting. Furthermore, processing time is wasted since the end point of the decomposition reaction cannot be accurately established. Finally, since the first surface tensile force is remarkably different from the second surface tensile force, extracting efficiency is decreased.

### SUMMARY OF THE INVENTION

Accordingly, a feature of an embodiment of the present invention is directed extracting the impurities on a wafer while providing at least one of the following: adaptability to wafer size; minimizing adequate decomposing time; increasing the reacting velocity with various kinds of the layers coated on the wafer; and increasing the extracting efficiency of the extraction solution.

According to one exemplary embodiment of the present invention at least one of the above features may be realized by providing an impurity extraction apparatus for extracting impurities on a substrate which includes a receiving module for receiving the substrate, a decomposing module for decomposing the layer coated on the substrate, and an extracting module for extracting impurities in the layer. A transfer module for transferring the substrate among the receiving module, the decomposing module and the extracting module may also be included.

The receiving module may receive various sizes of the substrates. The decomposing module decomposes the layer on the surface of the substrate transferred from the receiving module, so that impurities in the layer are exposed. The extracting module injects an extraction solution to the surface of the substrate and extracts the impurities on the surface of the substrate. The extracting module moves over the entire surface of the substrate to thereby extract impurities on the whole surface of the substrate. The transfer module transfers the substrate from the receiving module to the decomposing module, and from the decomposing module to the extracting module.

The decomposing module may include a processing chamber, a supply unit, a discharging unit, and a sensing unit for detecting the discharged material discharged from the processing chamber. The layer on the substrate chemically reacts with reacting material from the supply unit and is chemically decomposed in the processing chamber. By-products of the chemical reaction are discharged from the processing chamber through the discharging unit. The sensing unit detects the volume of the discharged material. By comparing the detected volume of the discharged material with a prior discharged volume, an end point at which the chemical reaction may be terminated can be determined. The supply unit may also include a nebulizer for supplying the reacting material as an aerosol and a first supply source connected to the nebulizer and containing the reacting material. The sensing unit may include a light source outputting infrared light, and a detector for detecting the infrared light having interacted with the discharged material.

The extracting module may include a support for supporting the substrate, a nozzle part, a rotator for moving the nozzle part, a solution reservoir for containing the extraction solution, and a plurality of storage compartments. The nozzle part may have an injector for injecting the extraction solution, a container for temporarily containing the extraction solution, a body that encloses the injector and the container and includes a contact enlarging portion for enlarging a contact surface with the extraction solution, and a controller for controlling injection of the extraction solution in the container and recovery of the extraction solution including the impurities to the container. The contact-enlarging portion may have a curved surface symmetrical to a centerline of the injector.

At least one of the above and other features may be realized by providing a decomposing device for decomposing a layer on a substrate in a wet chemical analysis facility. The decomposing device includes a processing chamber, a supply unit, a discharging unit, and a sensing unit. The layer on the substrate for fabricating a semiconductor device chemically reacts to a reacting material from the supply unit and is chemically decomposed in the processing chamber. By-products of the chemical reaction are discharged from the processing chamber through the discharging unit. The sensing unit detects the volume of the discharged material discharged from the processing chamber. By comparing the detected volume of the discharged material at an arbitrary time with a prior discharged volume at a time prior to the arbitrary time, an end point at which the chemical reaction may be terminated can be determined. The supply unit may also include a nebulizer for supplying the reacting material as an aerosol, and a first supply source that is connected with the nebulizer and contains the reacting material. The sensing unit may include a light source outputting infrared light and a detector receiving the infrared light having interacted with the discharged spent materials, thereby detecting the volume thereof.

At least one of the above and other features may be realized by providing an extracting device for extracting impurities in a layer on a substrate in a wet chemical analysis facility for fabricating a semiconductor device. The extracting device includes a support for supporting the substrate, and a nozzle part. The nozzle part may include an injector for injecting the extraction solution, a container for temporarily containing the extraction solution, a contact-enlarging portion for enlarging a contact surface with the extraction solution, and a body enclosing the injector and the container. The extracting device may include a controller for controlling injection of the extraction solution in the container and recovery of the extraction solution including the impurities to the container. The contact-enlarging portion may have a curved surface symmetrical to a centerline of the injector. Therefore, the surface tensile force applied to the extracting solution by the injector is reinforced, so that the extraction solution injected from the injector makes contact with the surface of the substrate forming a droplet shape. The extracting device may also include a rotator for moving the nozzle part, a solution reservoir for containing the extraction solution, and a plurality of storing compartments.

At least one of the above and other features may be realized by providing an extracting method of extracting impurities in a layer on a surface of a substrate. The substrate is provided in a processing chamber of a decomposing module. A reacting material may be supplied into the processing chamber as an aerosol state by a nebulizer. The layer coated on the substrate chemically reacts on the reacting material, and is chemically decomposed. By-products of the chemical reaction are discharged from the processing chamber. The volume of the discharged material is detected. An end point at which the chemical reaction may be terminated may be determined in accordance with the detected volume. After termination, the substrate including the decomposed layer is transferred to a support in an extracting module for extracting the impurities in the layer. Subsequently, an extraction solution is injected on a surface of the substrate through an injector of a nozzle part, and the nozzle part is moved over the entire surface of the substrate, so that all of the impurities on the entire surface of the substrate are extracted.

The aerosol of the reacting material may be created using a nebulizer and may be heated through a heat block enclosing the nebulizer before the reacting material is supplied to the processing chamber. The volume of the discharged materials may be detected by using infrared light. The extraction solution moves the surface of the substrate with a shape of a droplet by a surface tension applied between the extraction solution and a contact-enlarging portion coupled to the injector in a body, so that the extraction solution is rotated on a central axis of the droplet. The extracting solution including impurities is recovered into a container of the nozzle part, and the nozzle part is transferred to a storage compartment. The storage compartment is selected from a series of storing parts according to analysis characteristics for the impurities. Finally, the extraction solution is stored in the storage compartment.

Various sizes of wafers may be loaded into the receiving module of the same extracting apparatus. The reacting gas may be supplied as an aerosol, e.g., by using the nebulizer, so that the required time for decomposing the layer can be shortened and various kinds of layer can be decomposed. The end point of the chemical reaction can be accurately determined. The extraction solution including impurities can be prevented from being cut off from the nozzle part by increasing the surface tensile force between the extraction solution and the nozzle part, to thereby increase the extraction efficiency.

### BRIEF DESCRIPTION OF THE DRAWINGS

The above and other features and advantages of the present invention will become readily apparent to those of skill in the art be describing in detail embodiments thereof with reference to the attached drawings, in which:

FIG. 1 is a schematic illustration of a structure of an extraction apparatus for extracting impurities on a wafer according to an embodiment of the present invention:

FIG. 2A illustrate a cross section of the receiving module of the extraction apparatus;

FIG. 2B illustrates a plan view of a slot shown in FIG. 2A;

FIG. 3 is a schematic view of the structure of the decomposing module of the extraction apparatus shown in FIG. 1;

FIG. 4 is a schematic view of a structure of the sensing unit in the decomposing module shown in FIG. 3;

FIG. 5 is a graph of the densities of the HF gas and the SiF₄ gas as a function of time;

FIG. 6 is a schematic view of the structure of the extracting module of the extraction apparatus shown in FIG. 1;

FIG. 7 illustrates a sectional view of the structure of the nozzle part showing in FIG. 6;

FIGS. 8A to 8F illustrate partial sectional views for explaining the process for extracting impurities on the wafer according to the present invention;

FIG. 9 is a flow chart explaining the process for extracting impurities on the wafer according to an exemplary embodiment of the present invention; and

FIG. 10 is a graph of the extraction efficiency with respect to the concentration of the impurities.

### DETAILED DESCRIPTION

Korean Application No. 2002-82413, filed on Dec. 23, 2002, in the Korean Intellectual Property Office, and entitled: “A METHOD OF EXTRACTING IMPURITIES ON A SUBSTRATE AND AN APPARATUS USING THEREOF,” is incorporated herein by reference in its entirety.

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art. In the drawings, the thickness of layers and regions are exaggerated for clarity. Like numbers refer to like elements throughout.

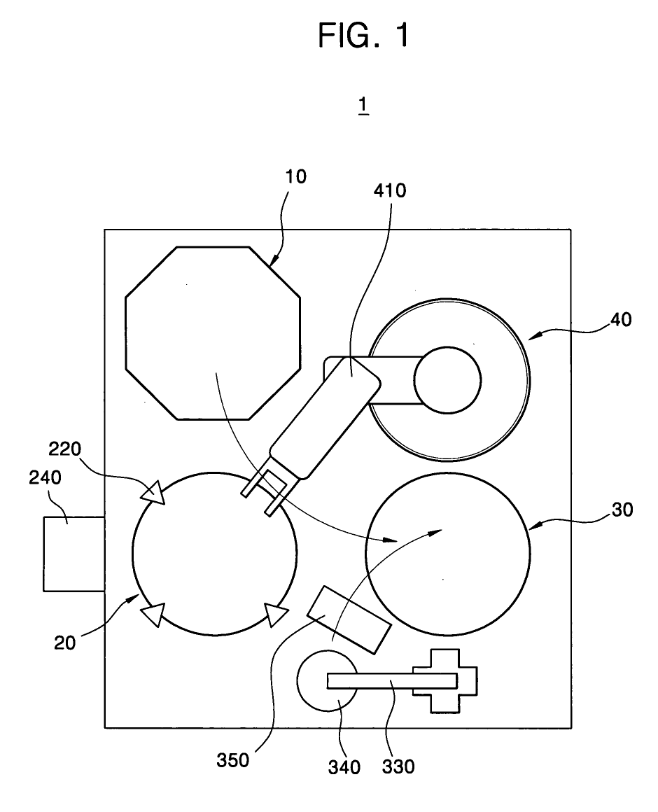

FIG. 1 is a schematic illustration showing a structure of an extraction apparatus for extracting impurities on a substrate according to an exemplary embodiment of the present invention.

Referring to FIG. 1, the extraction apparatus 1 includes a receiving module 10 for receiving the substrate, a decomposing module 20 for decomposing a layer on a surface of the substrate transferred to the receiving module 10, an extracting module 30 for extracting impurities remaining on the surface of the substrate, and a transfer module 40 for transferring the substrate from the receiving module 10 to the decomposing module 20, and from the decomposing module 20 to the extracting module 30. The substrate may be a wafer for fabricating a semiconductor device.

The receiving module 10 receives various sizes of a wafer for analysis impurities in a layer on a surface of the wafer. The wafer is transferred to the decomposing module 20 by the receiving module 10, and is again transferred to the receiving module 10 from the extracting module 30 by the transfer module 40 after completing the process for extracting impurities on the wafer.

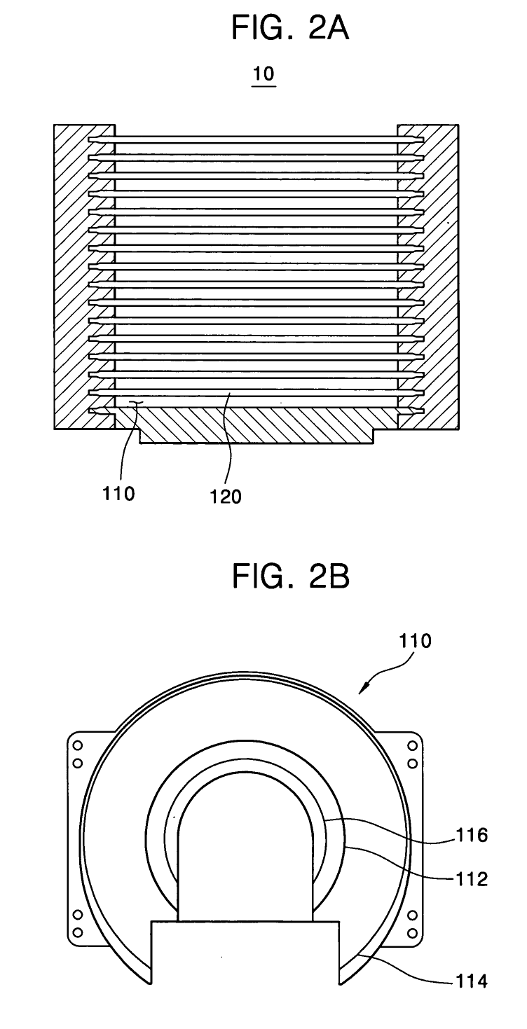

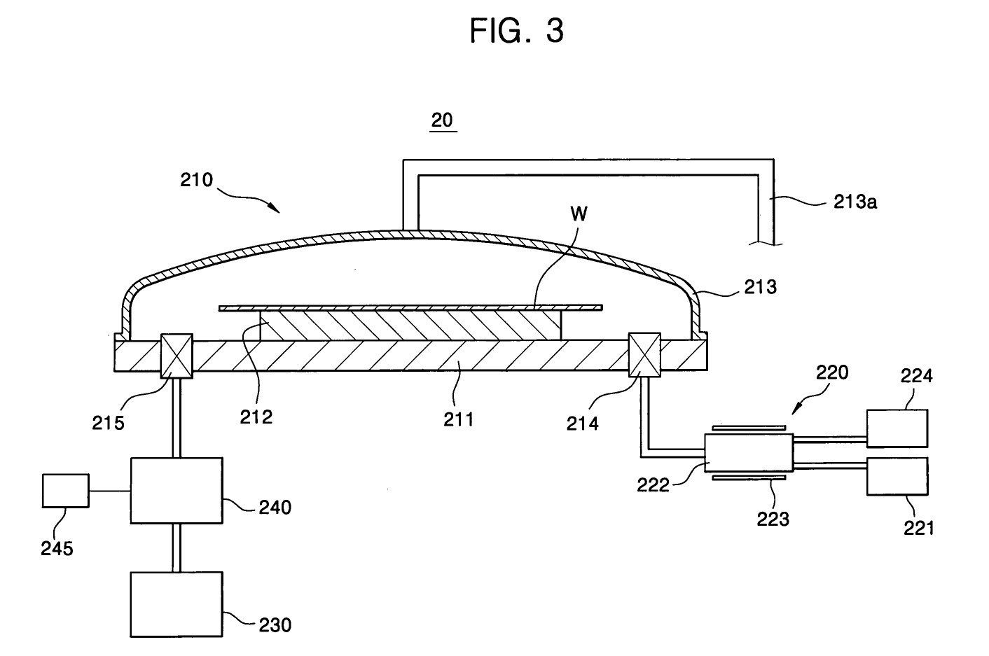

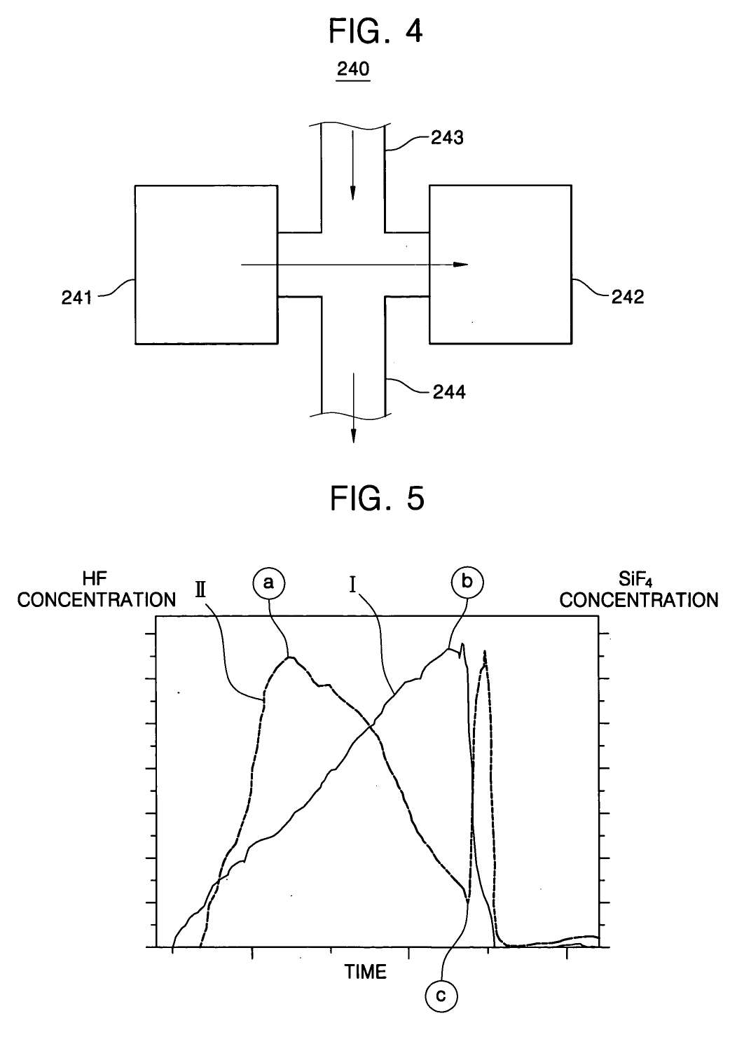

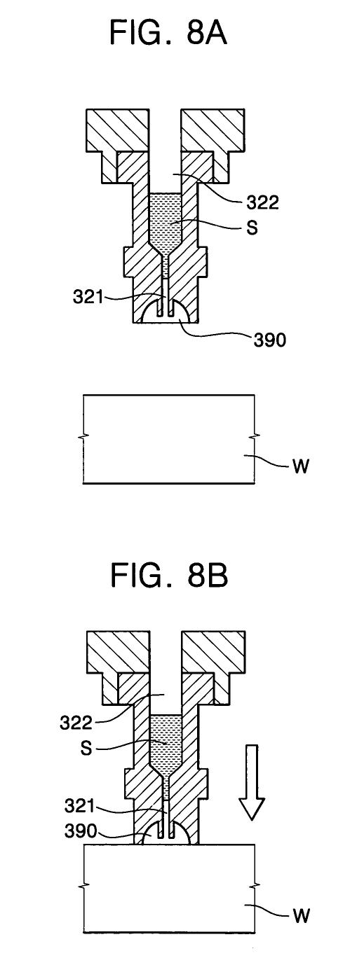

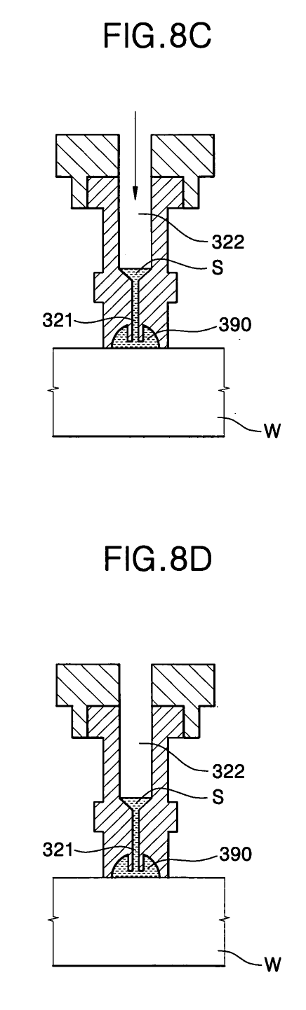

The receiving module 10 will be described in detail in FIGS. 2A and 2B. The decomposing module 20 includes a supply unit 220 and a sensor unit 240, and will be described in detail in FIGS. 3-5. The extracting module 30 has a rotator 330, a solution reservoir 340 and a storage unit 350 associated therewith. The details regarding the extracting module 30 and these associated elements are set forth in FIGS. 6-7.

FIG. 2A illustrates a cross section of the receiving module of the extraction apparatus and FIG. 2B illustrates a plan view of a slot shown in FIG. 2A.

Referring to FIG. 2A, the receiving module 10 includes a plurality of slots 110 for receiving the wafer, and a plurality of separating walls 120 for separating the slots 110. Each of the slots 110 may have a plurality of concentric rings with different diameters in the same plane, and is vertically stacked up between separating walls 120, to thereby form the receiving module 10. For example, the receiving module 10 includes 25 slots capable of receiving 25 wafers.

Referring to FIG. 2B, one of the slots 110 may include a first annular receptacle 112 for receiving a wafer of a first size, e.g., a 200 mm wafer, and a second annular receptacle 114 for receiving a wafer of a second size, e.g., a 300 mm wafer. The first and second annular receptacles 112, 114 have the same center. Accordingly, when a 200 mm wafer is provided to the receiving module 10, the wafer is received in the first receptacle 112, and when a 300 mm wafer is provided to the receiving module 10, the wafer is received in the second receptacle 114. Therefore, various sizes of the wafer can be received in the same cassette, thereby improve the processing efficiency. The first receptacle 112 may further include an auxiliary concentric ring 116 in the same plane, the auxiliary concentric ring 116 being able to receive a 150 mm wafer. If desired, another concentric member may be installed inside the auxiliary concentric ring 116 in the same plane for receiving the wafer having a diameter less than 150 mm, or additional annular receptacle may be provided for receiving wafers having sizes between the first and second sizes, or greater than the second size, as would be known to one of the ordinary skill in the art.

All of the first receptacle 112, the second receptacle 114, and the auxiliary concentric ring 116 may be made of aluminum (Al), in order to prevent deflection thereof, and having polytetrafluoroethylene (PTFE) deposited on the surface thereof for preventing contamination by the extraction solution.

FIG. 3 is a schematic illustration of the structure of the decomposing module 20 of the extraction apparatus shown in FIG. 1. The decomposing module 20 chemically decomposes the layer coated on the wafer and exposes the impurities in the layer.

Referring to FIG. 3, the decomposing module 20 includes a processing chamber 210 for decomposing the layer on the wafer by chemical reaction, a supply unit 220 which supplies a reacting material to the processing chamber 210, a discharge unit 230 which discharges materials including by-products of the chemical reaction from the processing chamber, and a sensing unit 240 which detects the discharged materials discharged from the processing chamber 210, to thereby determine an end point at which the chemical reaction may be terminated.

The processing chamber 210 includes a bottom portion 211, a support 212 installed on the bottom portion 211 for supporting the wafer, a dome-shaped cover 213 movably coupled to an edge of the bottom support 212 to thereby form an isolated space between the cover 213 and the bottom portion 211, an inlet 214 through which the reacting material is supplied, an outlet 215 through which the by-products of the chemical reaction are discharged. A lifter 213a is secured to the cover 213 for moving the cover 213. For example, a driving motor may move the lifter 213a upward and downward, so that the cover 213 also moves upward and downward. The support may be made of Teflon.

The wafer W is positioned on the support 212, and the cover 213 is secured to the bottom portion 211 to thereby seal the inside of the processing chamber 210. Next, the inlet 214 is opened and the reacting material is supplied into the processing chamber 210. A valve may be in the inlet 214 for controlling the supply volume of the reacting material. Hydrogen fluoride (HF) gas may be used as the reacting material. The composition of the reacting material may be changed in accordance with characteristics of the layer coated on the wafer, as would be known to one of the ordinary skill in the art.

When the layer on the wafer is an oxide layer, the HF gas reacts with the oxide layer as follows:

SiO₂ (s)+4HF→SiF₄+2H₂O(l) (1)

According to the chemical equation (1), the HF gas, which is supplied to the processing chamber 210 through the inlet 214, reacts with a silicon oxide layer on the wafer W. Then, a silicon tetrafluoride (SiF₄) gas, which is volatile and colorless, is produced as a by-product of the chemical reaction, and the silicon oxide layer on the wafer W is chemically decomposed. The SiF₄ gas is discharged through the outlet 215 from the processing chamber 210. An air valve and an exhaustion pump may be installed to the outlet 215 for improving the discharge efficiency. The aerosol state of the HF is heated and the HF gas is generated in the supply unit 220, which may include a minute particle generator such as a nebulizer.

The supply unit 220 may include a first supply source 221 containing liquid HF under high pressure, a nebulizer 222 for changing the liquid HF supplied from the first supply source 221 into an aerosol state, and a heater 223 for changing the aerosol state of the HF into a gaseous state of the HF. The heater 223 may be a heat-emitting wall enclosing the nebulizer 222. The heat-emitting wall may be able to heat the nebulizer 222 to about 100° C.

When high pressure liquid HF is provided into the nebulizer 222 from the first supply source 221, the liquid HF is emitted with very high velocity according to the Bernoulli fluid theorem, so that the liquid HF is changed into the aerosol state. The aerosol HF can be easily changed into gaseous HF by slightly heating the aerosol HF. Therefore, liquid HF or other reacting material can be changed into gaseous HF or other reacting material at a relatively low temperature compared with the temperature required in a conventional gas generator. A second supply source 224 including a carrier gas may be connected to the nebulizer 222 for accelerating the supply of the reacting material. The carrier gas carries the reacting material gas into the processing chamber 210. A nitrogen gas (N₂) may be used as the carrier gas. When liquid material at a high pressure passes through the nebulizer, the liquid material is changed into the aerosol state due to a pressure decrease. Regardless of the kind of the material, the aerosol material is changed into a gaseous state by a small amount of heat. Therefore, the reacting material can be selected with regard to the composition of the layer regardless of the saturation temperature and pressure thereof. In addition, the liquid reacting material can be uniformly changed into the aerosol state in the nebulizer 222, so that the gas reacting material can also be uniformly supplied into the processing chamber.

When the discharged material including the by-products of the chemical reaction is discharged through the outlet 215, the sensing unit 240 detects the volume of the discharged materials. A controller 245 receives the detected volume and may either automatically determine the end point at which the chemical reaction is to be terminated in accordance with the detected volume of the discharged materials and/or output the detect volume for a user to make this determination. The controller may automatically terminate the chemical reaction, e.g., by ceasing the flow of the reacting material once it has made this determination.

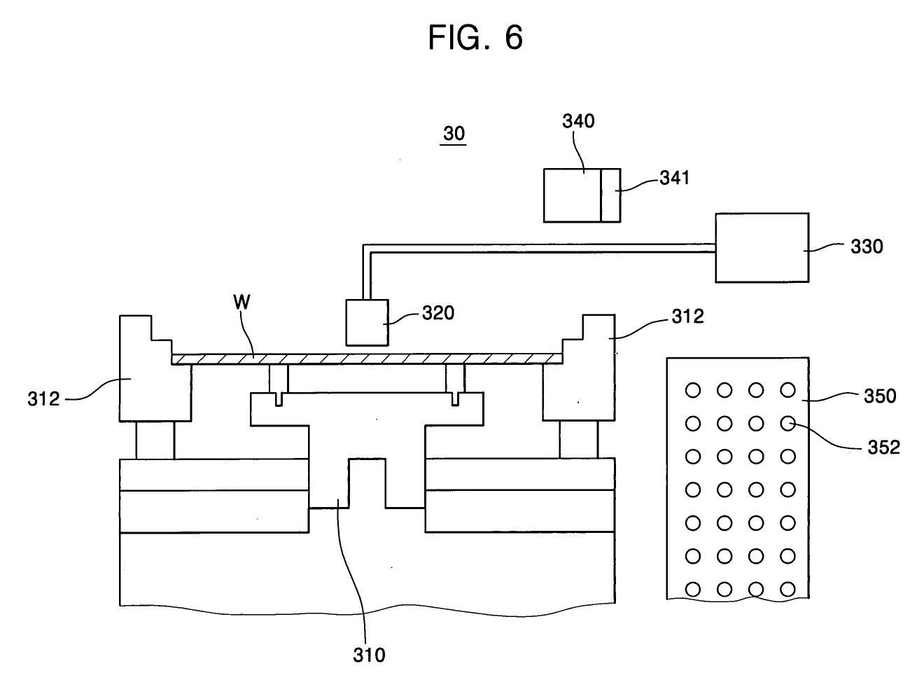

FIG. 4 is a view schematically showing a structure of the sensing unit in the decomposing module shown in FIG. 3.

Referring to FIG. 4, the sensing unit 240 may include a light source 241 that outputs light, a light detector 242 which receives light having interacted with a flowing material, an inlet tube 243 and an outlet tube 244 for respectively inputting and outputting the flowing material disposed between the light source 241 and the light detector 242. As used herein, the flowing material is the discharged material from the processing chamber 210.

The light source 241 outputs infrared light to the discharged material. The infrared light incident on the discharged material collides with the particles of the discharged material and is absorbed by the discharging material. Therefore, the wavelength of the infrared light from the light source 241 is different from the wavelength of the light interacting with the discharged material onto the detector 242. The higher the volume of the discharged material, the more infrared light is absorbed by the discharged material. Therefore, detection of the wavelength change gives information about the volume of the discharged material. At the beginning of the chemical reaction in the decomposing module, most the discharged material is the product of the chemical reaction, e.g., SiF₄ gas. However, at the end of the chemical reaction, most of the discharged material is the reacting material, e.g., HF gas.

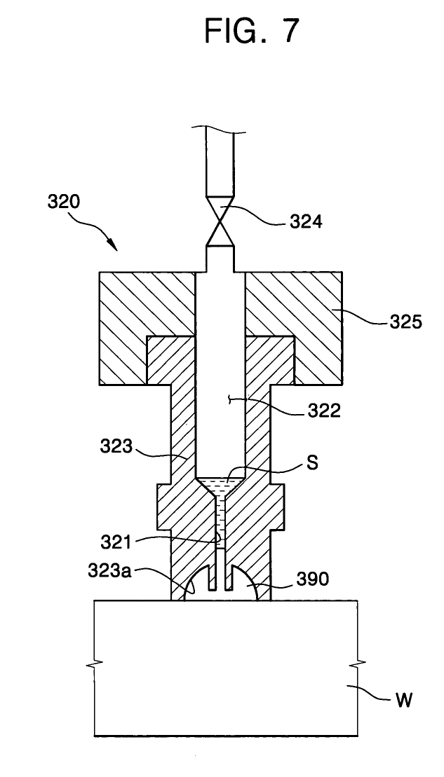

FIG. 5 is a graph of the densities of the HF gas and the SiF₄ gas as a function of time. In FIG. 5, a horizontal line indicates the time and a vertical line indicates the density of the HF gas and the SiF₄ gas. Graph I shows the density of the HF gas with respect to the time and the graph 11 shows the density of the SiF₄ gas with respect to the time.

Referring to FIG. 5, most of the supplied HF gas reacts to the layer on the wafer at the beginning of the chemical reaction, so that little of the HF gas discharged, while much of the SiF₄ gas is discharged. As the chemical reaction for decomposing the layer on the wafer advances, the layer is gradually diminished. Therefore, more and more HF gas is discharged, while less and less SiF₄ gas is discharged, since the chemical reaction with the layer is reduced. The discharged volume of the SiF₄ gas increases and reaches a maximum point \mathring{a}. After passing the maximum point \mathring{a}, the discharged volume of the SiF₄ gas gradually decreases. When the layer is completely decomposed and is no longer coated on the wafer, the chemical reaction between the layer and the HF gas is stopped. Therefore, most of the supplied HF gas is discharged from the processing chamber 210, while the SiF₄ gas is scarcely discharged from the processing chamber 210. The time at which most of the H F gas is discharged and little of the SiF₄ gas is discharged may be a desired end point of the chemical reaction. This end point is determined as a time at which the volume of the discharged HF gas is maximized at point \mathring{b} and/or the volume of the discharged SiF₄ gas is minimized at point \mathring{c}.

The sensing unit detects the volume of the reacting gas or the produced gas discharged from the processing chamber, and compares the detected volume with an immediately preceding volume. It is then determined whether or not the detected volume is maximized or minimized. That is, when the time-sequentially detected volume is less than the prior volume, the volume of the discharged material is estimated to pass the maximum point, and vice versa. Therefore, a lower or higher volume of the respective discharged materials compared with the prior volume indicates that the chemical reaction in the decomposing module is coming to an end. Detecting the volume of the discharging material can reveal the true end point of the chemical reaction, thus reducing the time for operation. The monitoring of whether a maximum or a minimum has been reached and the cessation of the supply of the reacting gas may be performed by a user or may be automated.

The discharge unit 230 is connected to the outlet tube 244 of the sensing unit 240. The discharge unit 230 may include an element for accelerating the discharge of the material from the processing chamber 210. For example, the discharge unit 230 may include a pump (not shown) for applying a discharging pressure to the outlet tube 244.

FIG. 6 is a schematic view of the structure of the extracting module of the extraction apparatus shown in FIG. 1.

Referring to FIG. 6, the extracting module 30 includes a support 310 for supporting the wafer W including impurities, a nozzle part 320 for injecting and discovering the extraction solution, a rotator 330 for moving the nozzle part, a solution reservoir 340 for reserving the extraction solution, and a storage unit 350 having storage compartments 352 for storing the recovered extraction solution including impurities in view of their analysis characteristics.

The support 310 may be secured to a bottom portion of the extracting module 30, and may include a pair of centering guides 312 to insure the center of the support 310 coincides with the center of the wafer W. The centering guides 312 support a peripheral portion of the wafer W, and includes a stepped portion for supporting the various sizes of the wafer W. The centering guides 312 shown in FIG. 6 allow the center of the support 310 to coincide with the center of either the 200 mm wafer or the 300 mm wafer, or other size of wafer that may be received by the receiving module 10.

The extraction solution for extracting impurities is injected onto the surface of the wafer W from the nozzle part 320. FIG. 7 is a sectional view showing the structure of the nozzle part 320 shown in FIG. 6.

Referring to FIG. 7, the nozzle part 320 includes an injector 321 for injecting the extraction solution S, a container 322 connected to the injector 321 and temporarily contains the extraction solution S, a body 323 enclosing the injector 321 and the container 322 with a contact enlarging portion 323a for enlarging a contact surface with the extraction solution S. A controller 324 controls injection of the extraction solution S in the container 322 and recovery of the extraction solution including the impurities to the container 322.

The injector 321 may be a micro tube or a nozzle installed on the body 323. The wafer W and the injector 321 are spaced from each other at a predetermined distance, so that the injected extraction solution can be injected on the surface of the wafer W. The distance between the wafer W and the injector 321 is minimized to thereby minimize the surface tension applied by the injector 321.

The container 322 is connected to the injector 321 and temporarily contains the extraction solution S supplied from the solution reservoir 340. Therefore, the extraction solution supplied from the solution reservoir 340 is temporarily held in the container 322, and then is injected to the surface of the wafer W, to thereby extract the impurities on the wafer W. The extraction solution including the impurities is recovered into the container 322, to thereby be transferred to a storing part 352 in the storing unit 350.

The body 323 forms an external shape of the nozzle part 320 with enclosing the injector 321 and the container 322. A top portion of the body 323 is covered with a nozzle header 325 for coupling to the rotator 330. A bottom portion of the body 323 opposite to the top portion of body 323 nearly makes contact with the surface of the wafer W. The bottom portion of the body 323 is recessed with a predetermined curvature to thereby form the contact enlarging portion 323a. Therefore, an extraction space 390 is formed between the contact-enlarging portion 323a and the surface of the wafer W. An end of the injector 321 protrudes through the contact enlarging portion 323a into the extraction space 390. The contact-enlarging portion 323a is symmetrical to the centerline of the injector 321. When the extraction solution S is injected to the surface of the wafer W, the surface tension on the extraction solution S is applied by the contact enlarging portion 323a as well as by the surface of the wafer W. In this example, since the contact-enlarging portion 323a is formed into a concave shape, the surface tension applied in the curved surface by the contact enlarging portion 323a, the extraction solution is more spherical than that of the extraction solution injected from the conventional nozzle system.

According to the conventional nozzle system, the surface tension is only applied by the surface of the wafer W and an inner surface of the injector 321, so that the surface tension is not strong enough to maintain the injected extraction solution in a droplet shape when the nozzle part 320 is moved. Therefore, the injected extraction solution is separated from the injector 321 and spreads on the surface of the wafer W. That is, the droplet of the extraction solution is separated from the injector 321, so that all of the extraction solution including impurities cannot be recovered into the container 322. However, according to the present nozzle part, the contact enlarging portion 323a maximizes the surface tension on the extraction solution to thereby be formed into the spherical shape. Therefore, the extraction solution can be stuck on the injector 321 while moving on the surface of the wafer W for extracting the impurities.

In addition, since the extraction solution is formed into the droplet shape, the extraction solution can be readily rotated on the central axis thereof so that an extraction solution neighboring the surface of the wafer W or a bottom portion of the extraction space 390 (hereinafter, referred to as bottom extraction solution) can be well mixed with an extraction solution neighboring an outlet of the injector 321 or a top portion of the extraction space 390 (hereinafter, referred to as top extraction solution).

According to the conventional nozzle system, only the bottom extraction solution extracts the impurities on the wafer and the top extraction solution does not contribute the extraction of the impurities. When the bottom extraction solution is saturated with the impurities, the extraction solution does not extract any additional impurities even though the top extraction solution has not been saturated. Therefore, the top extraction solution is wasted, and extraction efficiency is very poor. However, according to the present nozzle part, the top extraction solution and the bottom extraction solution can be well mixed, and both the bottom and top extraction solution can extract the impurities on the wafer to thereby remarkably improve the extraction efficiency.

The distance between a bottom surface of the body 323 and the surface of the wafer W may be set to prevent the extraction solution from spreading out to an exterior of the extraction space 390, e.g., to be about 0.05 mm. Therefore, the injected extraction solution is fixed within the extraction space 390 by the surface tension to form and maintain the droplet shape.

An upper end of the container 322, opposite to the injector 321, is connected with the controller 324 for controlling the injection and recovery of the extraction solution. When the controller 324 applies pressure to the container 322, the extraction solution S is injected to the surface of the wafer W through the injector 321. Then, the injected extraction solution moves on the whole surface of the wafer W while maintaining the droplet shape, and extracts all of the impurities on the wafer W. The extraction solution including the impurities is recovered into the container 322 by the pressure from the controller 324. Finally, the nozzle part 320 is transferred to one of the storage compartment 352 in the storage unit 350 in accordance with the analysis associated with the storage compartment. Therefore, the extraction solution is not separated from the injector and maintains the droplet shape while moving over the whole surface of the wafer W, thereby improving the extraction efficiency. The rotator 330 may spatially move in three-dimensional space, and may be made of aluminum (Al) coated with Teflon.

A nozzle head 325 is coupled with the upper portion of the nozzle part 320 and connects the nozzle part 320 with the rotator 330. The nozzle head 325 may be made of polyether ether ketone (PEEK). PEEK is an amorphous resin that is insoluble in a general solvent, and has good abrasion resistance, good heat resistance, good electrical insulation, and a self-lubricant property. The body 323 may be made of perfluoralkoxy (PFA) having good corrosion resistance and chemical resistance.

The solution reservoir 340 reserves the extraction solution for extracting impurities from a layer on a surface of the substrate, and is exemplary comprised of PFA for being insoluble to the extracting solution. The extraction solution is supplied from the solution reservoir 340, and is injected to the surface of the wafer through the nozzle part 320. As an exemplary embodiment, the solution reservoir 340 further includes a cleaning tray 341 for removing impurities remaining on the nozzle part 320. After the extraction solution with impurities is moved into a storage unit 350, the nozzle part 320 is again transferred to the solution reservoir 340. At that time, the nozzle part 320 moves at first to the cleaning tray 341, thus the impurities remaining on the nozzle part 320 is removed before the fresh extraction solution is supplied into the container 322 in the solution reservoir 340.

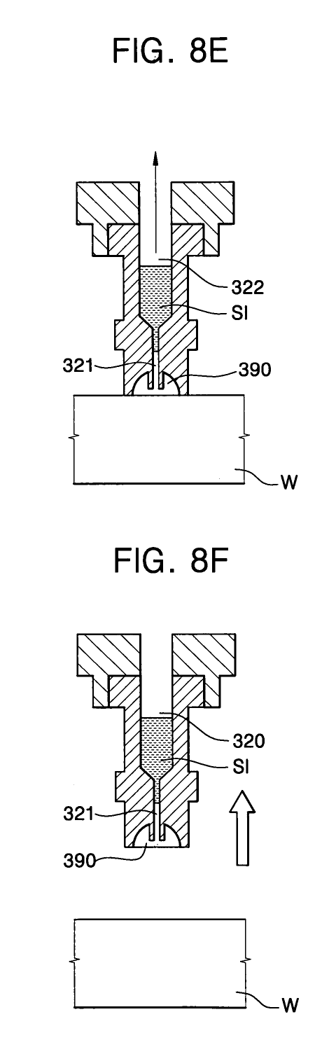

FIGS. 8A to 8F are partial views of the nozzle part 320 for explaining the process for extracting impurities on the wafer according to the present invention. In the following drawings and description thereof, the same reference numbers will be used to refer to the same or like parts as those shown in the previous drawings, FIGS. 1 to 7.

Referring to FIG. 8A, when the wafer W is positioned on the support 310 (shown in FIG. 6), the nozzle part 320 including the extraction solution is transported on the surface of the wafer W by the rotator 330 (shown in FIG. 7). Then, the rotator 330 moves downward to the surface of the wafer W to thereby separate from the surface of the wafer W with a predetermined distance as shown in FIG. 8B. Next, the controller 324 (shown in FIG. 7) pressurizes to the container 322, and the extraction solution S in the container 322 is injected onto the surface of the wafer W through the injector 321 as shown in FIG. 8C. Referring to FIG. 8D, the injected extraction solution S forms a droplet shape due to the surface tension, and extracts the impurities on the wafer W within the extraction space 390. At this time, the rotator 330 moves the nozzle part 320 over the whole surface of the wafer W, so that the impurities on the whole surface of the wafer W can be extracted into the extraction solution S. When the extraction process is completed, the extraction solution including the impurities (SI) is recovered into the container 322 by the pressure of the controller 324 as shown in FIG. 8E. Next, as shown in FIG. 8F, the rotator 330 moves the nozzle part 320 upward, and transports the nozzle part 320 to one of the storing places 352 (shown in FIG. 6) in accordance with analysis characteristics. After the extraction solution with impurities SI is deposited in a storing place 352, the nozzle part 320 is again transferred to the solution reservoir 340 (shown in FIG. 6), so that the fresh extraction solution is supplied into the container 322. Finally, the extraction solution with impurities SI in the storing place 352 is chemically analyzed, so that the contents and concentrations of the impurities are determined.

The extraction solution may be a mixture of hydrofluoric acid and hydrogen peroxide (H₂O₂), and the controller 324 may apply or reduce the pressure to the container 322 using a pump. For example, a quantitative pump may be used for the pump of the controller 324.

Referring again to FIG. 1, the transfer module 40 transfers the wafer from the receiving module 10 to the decomposing module 20, or from the decomposing module 20 to the extracting module 30. The transfer module 40 may include a robot arm 410. The robot arm 410 retrieves a wafer from the receiving module 10, and loads the wafer into the processing chamber 210 in the decomposing module 20. When the layer coated on the wafer is completely decomposed, the robot arm 410 moves the wafer onto the support 310 in the extracting module 30. When the impurities are completely extracted into the extraction solution, the robot arm 410 reloads the wafer to the receiving module 10, and loads another wafer to the decomposing module 20, to thereby complete a cycle of extracting the impurities.

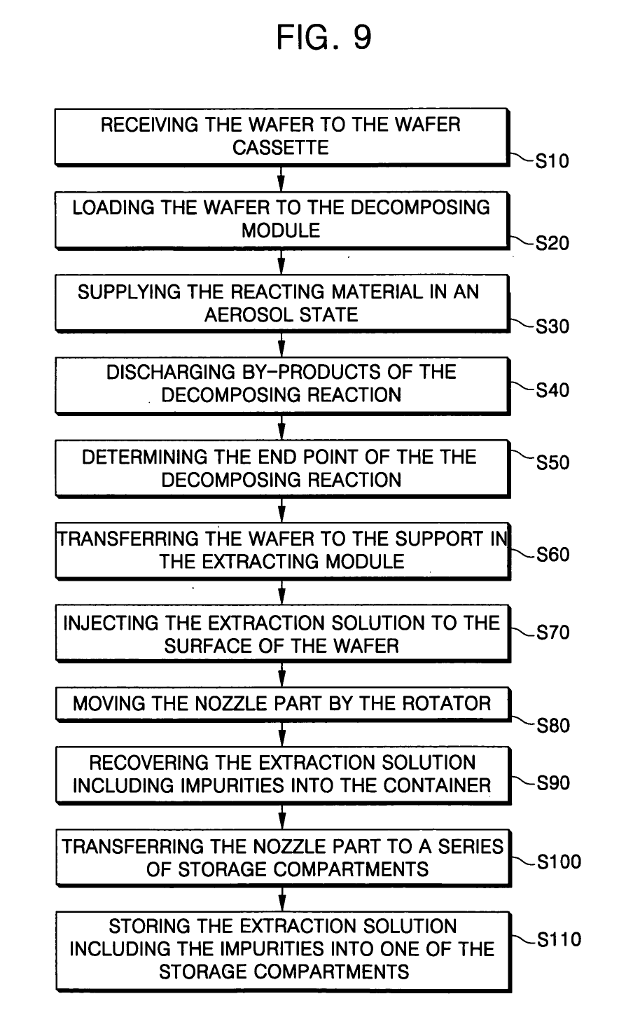

Hereinafter, the extracting process will be described in detail according to the extraction apparatus of the present invention with reference to FIG. 9. FIG. 9 is a flow chart for explaining the process for extracting impurities on the wafer according to an embodiment of the present invention.

Referring to FIG. 9, firstly, the wafer, which is a target wafer for analyzing impurities thereon, is received in the wafer cassette in the receiving module (step S10). The wafer cassette can receive various sizes of wafers, so that a plurality of wafer cassettes corresponding to respective sizes of the wafer is not necessarily needed, thereby improving process efficiency. In addition, the wafer cassette may be able to receive the wafer having a diameter less than about 150 mm. Next, the robot arm in the transfer module retrieves a wafer from the wafer cassette, and loads the wafer into the processing chamber in the decomposing module (step S20). The cover of the processing chamber is opened, and the wafer is positioned inside the processing chamber. Then, the cover of the processing chamber is secured to the bottom portion of the processing chamber, so that the inside of the processing chamber is isolated from the surroundings to form the closed space between the top cover and the bottom portion of the processing chamber. The reacting material is supplied into the closed space through the inlet (step S30). The reacting material is changed into an aerosol state through the nebulizer enclosed by the heater for heating the aerosol state of the reacting material. Therefore, the gaseous reacting material is supplied into the processing chamber. The reacting material may be about 50 weight percent of the HF. The reacting material reacts to the layer on the surface of the wafer, and the layer is chemically decomposed in the processing chamber. Discharged materials including by-products generated during the chemical reaction are output through the outlet from the processing chamber (step S40). A discharging pump may be used for discharging the discharged materials. The discharged materials pass the sensing unit, and the sensing unit detects the data for determining the end point of the chemical reaction (step S50). The sensing unit may include an infrared detector, and detects the volume of the discharged material from the processing chamber. The end point of the decomposing reaction is determined by comparing the present detected volume with the prior detected volume. That is, the maximum or minimum volume of the discharged material may be used for determining the end point of the decomposing reaction. When the layer is completely decomposed, the robot arm transfers the wafer to the support in the extracting module (step S60). Then, the rotator moves the nozzle part for injecting the extraction solution above the wafer, and the extraction solution is injected to the surface of the wafer through the injector (step S70). The injected extraction solution is formed into the droplet shape within the extraction space, and extracts all impurities in the extraction space on the wafer. The contact-enlarging portion formed on the bottom portion of the body extends the contact surface between the extraction solution and the injector, to thereby increase the surface tension and form the extraction solution into the droplet shape within the extraction space. The rotator moves the nozzle part on the whole surface of the wafer, so that all of the impurities on the wafer can be extracted into the extraction solution (step S80). The extraction solution can move over the whole surface of the wafer while remaining on the injector since the extraction solution is formed into a droplet shape. In addition, the extraction solution can be easily rotated on the central axis thereof due to the droplet shape. Therefore, the injected extraction solution is prevented from locally saturating at the bottom portion thereof to thereby improve the extraction efficiency. Furthermore, even if the wafer includes a stepped portion on its surface, the impurities can be extracted into the extraction solution, since the injected extraction solution is firmly stuck to the injector by reinforced the surface tension. The contact-enlarging portion may be a curved surface with a predetermined curvature to thereby improve the rotational ability of the extraction solution. Subsequently, the extraction solution including the impurities is recovered into the container by the pressure of the controller (step S90). Then, the nozzle part is transferred to a series of storage compartments (step S100), and the extraction solution in the container is stored into an appropriate storage compartment in view of analysis characteristics (step S110). The extraction solution in each of the storage compartments is chemically analyzed, and the contents and kind of the impurities determined.

Various sizes of wafers can be received in the same wafer cassette to thereby improve process efficiency. Providing the reacting material in an aerosol state improves the decomposing rate of the layer and allows various kinds of layers to be decomposed. The end point of the decomposing reaction can be accurately and objectively measured to thereby reduce the processing time.

Table 1 shows experimental results of the layer decomposition carried out by the conventional decomposing module and by the decomposing module of the present invention. The decomposing experiment was carried out with about 50 weight percent of the HF for an oxide layer and for a nitride layer on the wafer, respectively. The working hour of the HF gas was measured on condition that the decomposing module was kept on working during 24 hours.

TABLE 1

| | | The decomposing |
|---|---|---|
| | The conventional | module of the |
| | decomposing module | present invention |
| Concentration | Max. 0.3% | Max. 0.6% |
| of the HF gas | | |
| Decomposing rate | Oxide layer: | Oxide layer: |
| according to the | 600 Å/min | 2000 Å/min |
| kind of the layer | Nitride layer: | Nitride layer: |
| | 10 Å/min | 30 Å/min |
| Working hour | 48 hours | 144 hours |
| of the HF gas | | |

Table 1 indicates that the decomposing module of the present invention doubles the concentration of the generated HF, and roughly triples both the decomposing rate and the working hour as compared with the conventional decomposing module. Accordingly, Table 1 confirms that various features of the decomposing module significantly improve aspects of the processing efficiency.

In addition, the contact-enlarging portion of the body reinforces the surface tension of the injected extraction solution, so that the injected extraction solution formed into the droplet shape and remains in contact with the injector. Therefore, the injected extraction solution is prevented from detaching from the injector, and is prevented from locally saturating at the bottom portion thereof due to the sufficient rotation on the axis of the droplet, to thereby improve the extraction efficiency.

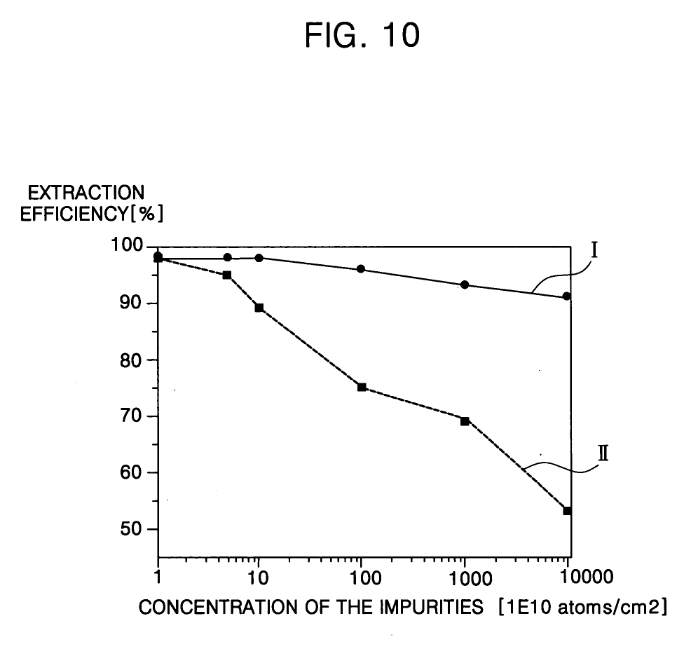

FIG. 10 shows plots of the extraction efficiency with respect to the concentration of the impurities. Graph I shows the extraction efficiency in the nozzle part including the contact-enlarging portion according to the present invention, and graph II shows the extraction efficiency in the conventional nozzle system.

Referring to FIG. 10, when the contacting surface between the injected extraction solution and the injector is enlarged to thereby reinforce the surface tension, the extraction efficiency is uniform with respect to the concentration of the impurities as shown in the graph I. The droplet of the extraction solution rotates on the central axis thereof, and the top and bottom portion of the extraction solution is well mixed. Therefore, local saturation at the bottom portion of the extraction solution is prevented, and the impurities extracted into the extraction solution rapidly spreads in the whole extraction solution. As a result, the injected extraction solution can sufficiently extract the impurities on the surface of the wafer, so that the extraction efficiency is not influenced by the concentration of the impurities. On the contrary, as shown in graph II, the extraction efficiency of the conventional nozzle system rapidly decreases as the concentration of the impurities increases. The bottom and top portion of the extraction solution is not well mixed, since the injected extraction solution is not formed into the droplet shape due to the weak surface tension. Therefore, after the bottom portion of the extraction solution is locally saturated with the impurities, no more impurities are extracted into the extraction solution. That is, the higher the concentration of the impurities on the wafer, the lower the extraction efficiency for the conventional system. As a result, graphs I and II indicate that the contact-enlarging portion improves the extraction efficiency of the impurities.

Embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An apparatus for extracting impurities from a layer on a surface of a substrate, the apparatus comprising:
a receiving module receiving the substrate, the receiving module being configured to receive a variety of sizes of substrates;
a decomposing module which chemically decomposes the layer on the surface of the substrate transferred from the receiving module, thereby exposing impurities in the layer; and
an extracting module which extracts the impurities on the surface of the substrate by injecting an extraction solution to the surface of the substrate and moving the extraction solution over an entire surface of the substrate.

2. The apparatus for extracting impurities from a layer on a surface of a substrate as claimed in claim 1, wherein the receiving module includes a plurality of slots separated by separating walls, the slots having a plurality of concentric rings with different diameters in a same plane.

3. The apparatus for extracting impurities from a layer on a surface of a substrate as claimed in claim 2, wherein each of the rings is aluminum (Al) coated with a polytetra fluoro ethylene (PTFE).

4. The apparatus for extracting impurities from a layer on a surface of a substrate as claimed in claim 1, wherein the decomposing module includes:
a processing chamber in which the layer on the substrate is decomposed by a chemical reaction between the layer and a reacting material;
a supply unit which supplies the reacting material to the processing chamber;
a discharging unit which outputs discharged materials, including by products of the chemical reaction, from the processing chamber; and
a sensing unit which detects a volume of the discharged materials; and
a controller that determines an end point of the chemical reaction in accordance with the volume detected by the sensing unit.

5. The apparatus for extracting impurities from a layer on a surface of a substrate as claimed in claim 4, wherein the supply unit includes a nebulizer supplying the reacting material as an aerosol and a first supply source connected with the nebulizer and containing the reacting material.

6. The apparatus for extracting impurities from a layer on a surface of a substrate as claimed in claim 5, wherein the nebulizer further includes a heater enclosing and heating the nebulizer.

7. The apparatus for extracting impurities from a layer on a surface of a substrate as claimed in claim 5, wherein the supply unit further includes a second supply source connected to the nebulizer and containing carrier gases.

8. The apparatus for extracting impurities from a layer on a surface of a substrate as claimed in claim 7, wherein the carrier gas includes nitrogen (N₂) gas.

9. The apparatus for extracting impurities from a layer on a surface of a substrate as claimed in claim 7, wherein the first supply source includes about 50 weight percent of hydrogen fluoride (HF).

10. The apparatus for extracting impurities from a layer on a surface of a substrate as claimed in claim 4, wherein the sensing unit includes a light source outputting infrared light and a detector receiving light having interacted with an inspected subject, thereby detecting the volume of the inspected subject.

11. The apparatus for extracting impurities from a layer on a surface of a substrate as claimed in claim 10, wherein the inspected subject includes the discharged materials from the processing chamber.

12. The apparatus for extracting impurities from a layer on a surface of a substrate as claimed in claim 4, wherein the extracting module includes:
a support for the substrate;
a nozzle having
an injector for injecting the extraction solution,
a container connected to the injector and temporarily holds the extraction solution, and
a body that encloses the injector and the container, the body including a contact enlarging portion for enlarging a contact surface with the extraction solution; and
a controller for controlling injection of the extraction solution in the container and recovery of the extraction solution including the impurities to the container.

13. The apparatus for extracting impurities from a layer on a surface of a substrate as claimed in claim 12, wherein the contact-enlarging portion has a curved surface symmetrical to a centerline of the injector.

14. The apparatus for extracting impurities from a layer on a surface of a substrate as claimed in claim 12, wherein the injector is made of polyether ether ketone (PEEK).

15. The apparatus for extracting impurities from a layer on a surface of a substrate as claimed in claim 12, wherein the extracting module further includes:
a rotator for moving the nozzle part;
a solution reservoir containing the extraction solution, thereby supplying the extraction solution to the nozzle part; and
a plurality of storing places for storing the recovered extraction solution including impurities, each of the storing places having different analysis characteristics.

16. The apparatus for extracting impurities from a layer on a surface of a substrate as claimed in claim 15, wherein the rotator is made of Teflon coated aluminum.

17. The apparatus for extracting impurities from a layer on a surface of a substrate as claimed in claim 15, wherein the rotator spatially moves in a three-dimensional space.

18. The apparatus for extracting impurities from a layer on a surface of a substrate as claimed in claim 15, wherein the reservoir further includes a cleaning tray for removing impurities remaining on the nozzle part after extracting the impurities.

19. The apparatus for extracting impurities from a layer on a surface of a substrate as claimed in claim 12, wherein the support includes a centering guide for guiding the substrate to a central portion thereof.

20. The apparatus for extracting impurities from a layer on a surface of a substrate as claimed in claim 12, wherein the extraction solution includes a mixture of hydrogen fluoride (HF) and hydrogen peroxide (H₂O₂).

21. The apparatus for extracting impurities from a layer on a surface of a substrate as claimed in claim 12, wherein the extracting module further includes a pump for injecting or recovering the extraction solution by the controller.

22. The apparatus for extracting impurities from a layer on a surface of a substrate as claimed in claim 1, further comprising a transfer module which transfers the substrate between the receiving module, the decomposing module, and the extracting module.

23. The apparatus for extracting impurities from a layer on a surface of a substrate as claimed in claim 22, wherein the transfer module includes an automatically controlled robot arm.

24. A device for decomposing a layer on a substrate in a wet chemical analysis facility for fabricating a semiconductor device, comprising:
a processing chamber for decomposing the layer on the substrate by chemical reaction with a reacting material;
a supply unit supplying the reacting material to the processing chamber;
a discharging unit which discharges spent materials including by products of the chemical reaction from the processing chamber;
a sensing unit which detects a volume of the spent materials; and
a controller that determines an end point at which the chemical reaction is to be terminated in accordance with the volume detected by the sensing unit.

25. The device for decomposing a layer on a substrate as claimed in claim 24, wherein the controller is a user.

26. The device for decomposing a layer on a substrate as claimed in claim 24, wherein the supply unit includes a nebulizer for supplying the reacting material as an aerosol and a first supply source connected with the nebulizer and containing the reacting material.

27. The device for decomposing a layer on a substrate as claimed in claim 26, wherein the nebulizer further includes a heat block enclosing and heating the nebulizer.

28. The device for decomposing a layer on a substrate as claimed in claim 24, wherein the supply unit further includes a second supply source connected with the nebulizer and containing carrier gases.

29. The device for decomposing a layer on a substrate as claimed in claim 24, wherein the sensor includes a light source outputting infrared light and a detector receiving infrared light reflected from an inspecting subject, thereby for detecting the volume thereof.

30. The device for decomposing a layer on a substrate as claimed in claim 29, wherein the inspecting subject includes the spent materials discharged from the processing chamber.

31. A device for extracting impurities on a substrate in a wet chemical analysis facility for fabricating a semiconductor device, comprising:
a support for the substrate;
a nozzle part including
an injector for injecting the extraction solution onto substrate on the support,
a container connected to the injector and containing the extraction solution,
a contact enlarging portion for enlarging a contact surface with the extraction solution, and
a body enclosing the injector and the container; and
a controller for controlling injection of the extraction solution from the container and recovery of the extraction solution including the impurities to the container.

32. The device for extracting impurities on a substrate as claimed in claim 31, wherein the contact-enlarging portion has a curved surface symmetrical to a centerline of the injector.

33. The device for extracting impurities on a substrate as claimed in claim 31, further comprising:
a rotator for moving the nozzle part;
a solution reservoir for containing the extraction solution therein, thereby supplying the extraction solution to the nozzle part; and
a plurality of storage compartments for storing the recovered extraction solution including impurities, each of the storage compartments having different analysis associated therewith.

34. The device for extracting impurities on a substrate as claimed in claim 33, wherein the injector is made of polyether ether ketone (PEEK) having a good chemical resistance and the rotator is made of Teflon-coated aluminum.

35. The device for extracting impurities on a substrate as claimed in claim 33, wherein the rotator spatially moves in a three-dimensional space.

36. The device for extracting impurities on a substrate as claimed in claim 33, wherein the solution reservoir further includes a cleaning tray for removing impurities remaining on the nozzle part after extracting the impurities.

37. A method of extracting impurities in a layer on a surface of a substrate, comprising:
providing the substrate in a processing chamber;
supplying an aerosol of a reacting material to the processing chamber;
discharging spent materials including by-products of a chemical reaction between the reacting material and the layer;
determining an end point at which the chemical reaction may be terminated by detecting a volume of the discharged materials discharged from the processing chamber;
injecting an extraction solution onto the surface of the substrate through an injector of a nozzle part; and
moving the nozzle part with the extraction solution over an entirety of the surface of the substrate.

38. The method of extracting impurities in a layer on a surface of a substrate as claimed in claim 37, further comprising heating the aerosol of the reacting material before the reacting material is supplied to the processing chamber.

39. The method of extracting impurities in a layer on a surface of a substrate as claimed in claim 37, wherein the determining an end point includes detecting a volume of the materials discharged from the processing chamber, and a comparing a present detected volume with a prior detected volume of the discharged materials.

40. The method of extracting impurities in a layer on a surface of a substrate as claimed in claim 37, wherein the moving of the extraction solution includes providing surface tension between the extraction solution and a contact enlarging portion coupled to the injector, the surface tension creating a droplet of the extraction solution, and rotating the extraction solution on a central axis of the droplet.

41. The method of extracting impurities in a layer on a surface of a substrate as claimed in claim 40, wherein the rotating of the extraction solution further includes rotating on a central line of the injector.

42. The method of extracting impurities in a layer on a surface of a substrate as claimed in claim 37, further comprising
recovering the extracting solution including impurities into a container of the nozzle part;
transferring the nozzle part to a storage compartment for storing the recovered extraction solution including impurities, the storage compartment being selected from a series of storage compartments according to analysis characteristics for the impurities; and
storing the extraction solution including the impurities in the storage compartment.
